(19) United States
(12) Patent Application Publication
(10) Pub. No.: US 2019/0139067 A1
(43) Pub. Date: May 9, 2019

(54) METHOD AND APPARATUS FOR CLOUD SERVICE SYSTEM RESOURCE ALLOCATION BASED ON TERMINABLE REWARD POINTS

(71) Applicants: Kun Wang, Beijing (CN); Zhaoyang Hu, Beijing (CN)

(72) Inventor: Kun Wang, Beijing (CN)

(21) Appl. No.: 16/123,371

(22) Filed: Sep. 6, 2018

(30) Foreign Application Priority Data
Nov. 7, 2017 (CN) 201711083686.5
Nov. 7, 2017 (CN) 201711084430.6

(51) Int. Cl. G06Q 30/02

(52) U.S. Cl. CPC G06Q 30/0211; G06Q 30/0201; G06Q 30/0235

(57) ABSTRACT

A methods for cloud service system resource allocation based on terminable reward points includes predicting a development tendency of a point based on economic data related to point operation, and calculating a growth parameter of the reward point; calculating, based on data related to goods redeemed by using the reward point, a static parameter presenting a current status of the reward point; calculating a valuation coefficient of the reward point in combination with the growth parameter and the static parameter; calculating a point value by using the valuation coefficient and price data obtained based on the reward point and a price of the goods redeemed by using the reward point; and when obtaining the evaluated point value, comparing the evaluated point value with a current price and performing intelligent analysis on a historical status, to determine a scale of cloud service system resource allocation.

### CROSS-REFERENCE TO RELATED APPLICATION

This application claims the priority to Chinese Patent Application No. 201711083686.5 and 201711084430.6, both filed on Nov. 7, 2017 in the State Intellectual Property Office of P.R. China, which is hereby incorporated herein in its entirety by reference.

### FIELD OF THE INVENTION

The present invention relates to the field of virtual point cloud services, and in particular, to method and apparatus for cloud service system resource allocation based on terminable reward points.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

In order to attract customers and increase customers' activities, all kinds of platforms and merchants have issued their own virtual points. Informationalized virtual points of each merchant are based on cloud services. However, a current virtual-point cloud service device lacks of guidance in resource allocation and is unbalanced in data carrying, thereby resulting in decrease of the QoS of data of the reward points.

Dynamic resource allocating method based on load balance (LB) is currently the most widely used. A virtual machine (VM) carried on each host in a migration domain may migrate in the migration domain. Main steps of the method are: obtaining load indicators of all hosts and VMs in the migration domain through monitoring; determining whether the load indicators reach a migration trigger condition; and if the load indicators reach the migration trigger condition, performing online migration of the VMs, and selecting a VM from a high-load source host, to migrate to a low-load target host, so as to implement LB in the migration domain.

However, in the LB-based dynamic resource allocating method, only a load status at a current moment is considered, and a load conflict formed due to a customer flow change caused by volatility of future point values is not considered, resulting in decrease of the QoS of the VM. In addition, only the LB at the current moment is considered in existing dynamic resource allocation. As the LB changes, repeated migration easily occurs, wasting resources in a cloud data center.

Therefore, a heretofore unaddressed need exists in the art to address the aforementioned deficiencies and inadequacies.

### SUMMARY OF THE INVENTION

One of the objectives of this invention is to provide a method for cloud service system resource allocation that can be widely applicable to terminable virtual points issued by various institutions, to help to increase the efficiency of enterprise computers and improve the system security.

To achieve the foregoing objective, the present invention first provides a terminable reward point evaluation method to determine the terminable reward point as a threshold of a resource allocation system. The method includes the following steps:

predicting a development tendency of a point based on economic data related to point operation, and calculating a growth parameter of the reward point;

calculating, based on data related to goods redeemed by using the reward point, a static parameter presenting a current status of the reward point;

calculating a valuation coefficient of the reward point in combination with the growth parameter and the static parameter; and

calculating a point value by using the valuation coefficient and price data obtained based on the reward point and a price of the goods redeemed by using the reward point.

In one embodiment, the calculating a valuation coefficient of the reward point in combination with the growth parameter and the static parameter includes assigning a first weighting coefficient to the growth parameter, assigning a second weighting coefficient to the static parameter, and adding a product of the growth parameter and the first weighting coefficient to a product of the static parameter and the second weighting coefficient, to obtain the valuation coefficient.

In one embodiment, the calculating a point value by using the valuation coefficient and price data obtained based on the reward point and a price of the goods redeemed by using the reward point includes multiplying the price data by the valuation coefficient to obtain the reward point value.

In one embodiment, the predicting a development tendency of a point based on economic data related to point operation, and calculating a growth parameter of the reward point includes:

predicting future macroeconomic indicator data based on past economic indicator status data;

predicting, based on past and current operation data of an issue institution and with reference to the predicted macroeconomic indicator data, indicator data related to future point issue and consumption of the institution;

predicting a future point issue volume and consumption volume based on the indicator data related to the reward point issue and consumption;

discounting predicted values of the future point issue volume and consumption volume according to a Markowitz portfolio theory, a Gordon growth model, and a capital asset pricing model, to obtain an issue volume present value and a consumption volume present value; and

using a ratio of the consumption volume present value to the issue volume present value as the growth parameter of the reward point.

In one embodiment, the macroeconomic indicator includes one or more of a nominal gross domestic product (GDP), a consumer price index (CPI), and a real gross domestic product (Real GDP).

In one embodiment, the indicator data related to the future point issue and consumption of the institution includes one or more of a transaction volume, a sales volume, marketing costs, and a cash flow.

In one embodiment, the issue volume present value and the consumption volume present value are calculated by using the following models:

$${R}_{apv} = {\sum }_{t = 1}^{n} \frac{{R}_{at}}{{( 1 + r )}^{t}} , and {O}_{pv} = {\sum }_{t = 1}^{n} \frac{{O}_{t}}{{( 1 + r )}^{t}} ,$$

where Rₐₚᵥ is the active consumption volume present value, and Oₚᵥ is the issue volume present value.

In one embodiment, a method for obtaining the data related to the goods redeemed by using the reward point includes: obtaining a price of the reward point based on the reward point and the price data of the goods redeemed by using the reward point.

In one embodiment, the obtaining a price of the reward point based on the reward point and the price data of the goods redeemed by using the reward point includes:

obtaining an average book price P_{b} of the reward point based on a goods marked price of a redemption mall of a currently graded point and a currency price replaced with the reward point; and/or

obtaining an average realized price Pᵣ of the reward point based on a goods third-party fair price of a redemption mall of a currently graded point and a currency price replaced with the reward point; and/or

obtaining a Beta coefficient β_{β} of a point issue institution and/or a competition average Beta coefficient β_{cβ}_{_{c}} of the institution based on a Markowitz portfolio theory and a capital asset pricing model;

rating a goods liquidity of the redemption mall of the currently graded point, and calculating a liquidity of each type of goods, where goods having the best liquidity is assigned 1, and goods having the poorest liquidity is assigned 0; and calculating, after calculating an average goods liquidity, a liquidity parameter L of the goods redeemed by using the reward point, where L ranges between 0 and 1; and

calculating the static parameter in combination with the average book price P_{b}, the average realized price Pᵣ, the Beta coefficient β of the reward point issue institution, the competition average Beta coefficient β_{c} of the institution, and the liquidity parameter L, where a calculation model is:

$$static parameter = \frac{{P}_{r}}{{P}_{b}} * \frac{{β}_{c}}{β} * L .$$

According to another aspect, the present invention provides a resource allocation apparatus, to help a cloud service system to allocate resources based on an evaluated point value, and improve the computer operation efficiency.

A point issue volume and consumption volume and a company financial statement are imported; and data such as macroeconomic data that is required for point analysis is extracted.

A point is valuated by using a point value evaluation method and a computer, to obtain an evaluated point value; and appropriate algorithm optimization and encryption are performed, to improve the computer operation efficiency and security.

A current value of the reward point and the evaluated value are compared, and a cloud service system resource allocation decision is provided with reference to historical data.

A module conclusion is intelligently analyzed, and software and hardware resources in a resource pool are scheduled, to prepare for a sudden change of a service volume that may occur.

Based on the foregoing terminable reward point valuation method provided in the present invention, the present invention provides a software and hardware resource allocation apparatus for a computer cloud service system, which has the following beneficial effects.

Based on the foregoing point valuation method, the allocation apparatus can dynamically set a threshold of the computer cloud system. If an evaluated point value in the cloud service system is lower than a standard value or a current price, allocation of VMs and other physical resources of the cloud service system are decreased. Otherwise, if an evaluated point value in the cloud service system is lower than a standard value or a current price, allocation of VMs and other physical resources of the cloud service system are increased.

In addition, the apparatus has artificial intelligence and a data set analysis capability, and can intelligently adjust a threshold after having a data basis.

These and other aspects of the present invention will become apparent from the following description of the preferred embodiments, taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and, together with the written description, serve to explain the principles of the invention. The same reference numbers may be used throughout the drawings to refer to the same or like elements in the embodiments.

FIG. 1 shows schematically an apparatus for cloud service system resource allocation based on terminable reward points, according to one embodiment of the invention.

FIG. 2 is a flowchart of a method for cloud service system resource allocation based on terminable reward points according to one embodiment of the invention.

FIG. 3 is a flowchart of a terminable reward point valuation method according to one embodiment of the invention.

FIG. 4 shows point prediction and discounting results for company C according to one embodiment of the invention.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this invention, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

As used herein, the phrase “at least one of A, B, and C” should be construed to mean a logical (A or B or C), using a non-exclusive logical OR. As used herein, the term “and/or” includes any and all combinations of one or more of the associated listed items.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

As used herein, the terms “service system” or “server database” generally refers to a system that responds to requests across a computer network to provide, or help to provide, a network service. An implementation of the service system or server may include software and suitable computer hardware. A service system or serve may run on a computing device or a network computer. In some cases, a computer may provide several services and have multiple servers running.

The term “program” or “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The present invention in one aspect relates to method and apparatus for cloud service system resource allocation based on terminable virtual points. One of ordinary skill in the art would appreciate that, unless otherwise indicated, certain computer systems and/or components thereof may be implemented in, but not limited to, the forms of software, firmware or hardware components, or a combination thereof.

The apparatuses, systems, and/or methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

The embodiments of the present invention provide a resource allocating method and apparatus in a cloud service system, to allocate cloud service system resources of cloud computing of computers based on values of current points.

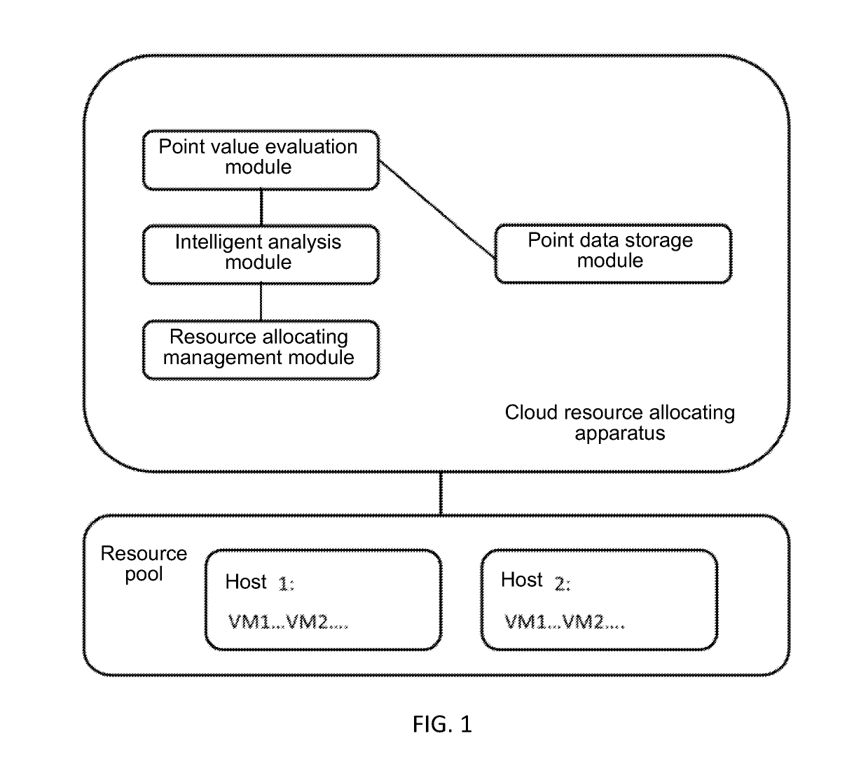

In one embodiment shown in FIG. 1, the apparatus includes a point data storage module, a point value evaluation module, an intelligent analysis module, and a resource allocating management module.

The reward point data storage module is configured to import data such as a point issue volume and consumption volume, a company financial statement, and macroeconomic data that are required for point analysis.

The reward point value evaluation module is configured to valuate a point by using a point value evaluation method and a computer to obtain an evaluated point value; and meanwhile, perform appropriate algorithm optimization and encryption to improve the computer operation efficiency and security.

The intelligent analysis module is configured to compare a current value of the reward point and the evaluated value, and provide a cloud service system resource allocation decision with reference to historical data.

The resource allocating management module is configured to intelligently analyze the conclusion of the intelligent analysis module, and allocate software and hardware resources in a resource pool, to prepare for a sudden change of a service volume that may occur.

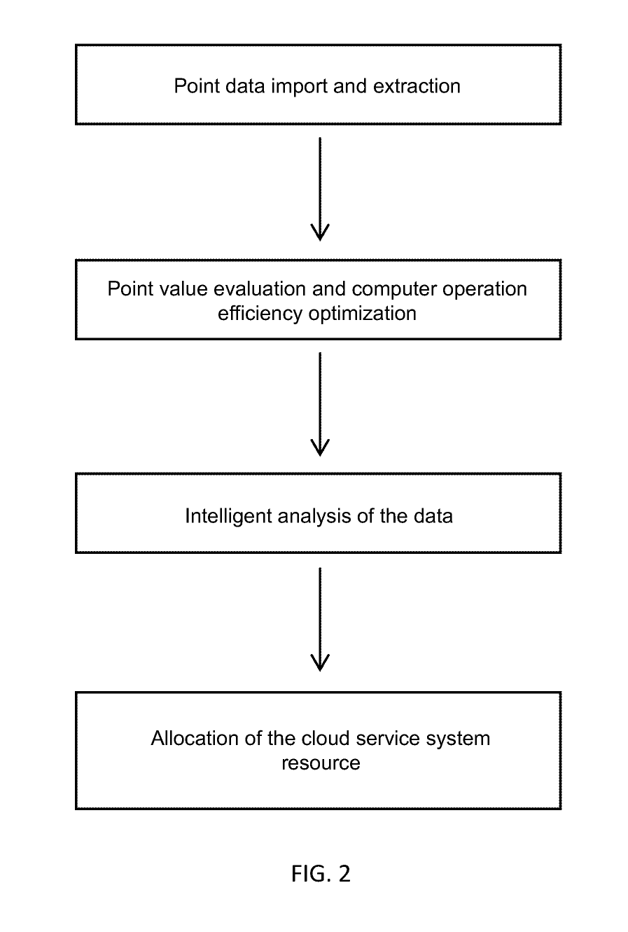

In the embodiment shown in FIG. 2, the resource allocating method includes point data import and extraction; point value evaluation and optimization of the computer operation efficiency; intelligent analysis of the data; and allocation of the cloud service system resource.

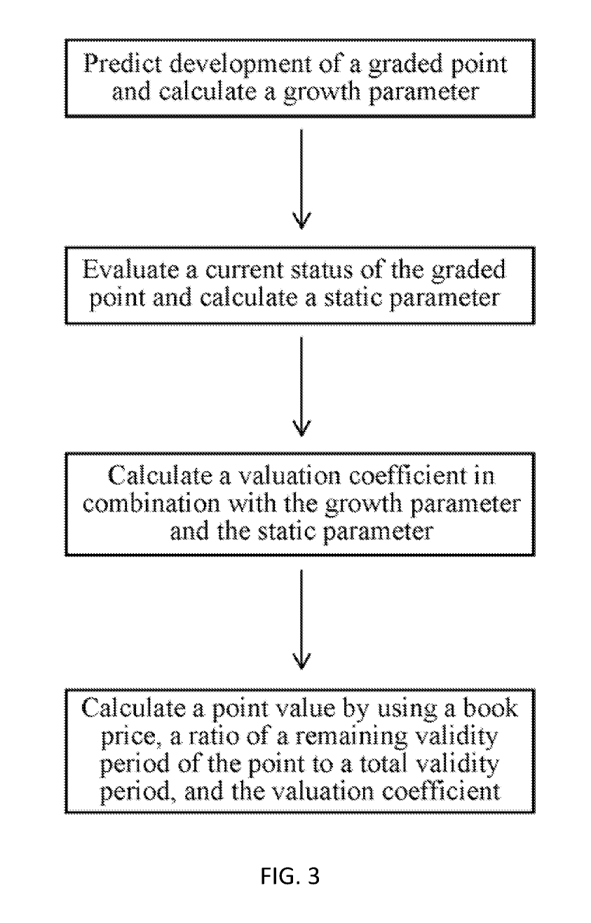

FIG. 3 shows schematically a terminable reward point valuation method according to one embodiment of the invention, which includes

predicting a development tendency of a point based on economic data related to point operation, and calculating a growth parameter of the reward point;

calculating, based on data related to goods redeemed by using the reward point, a static parameter presenting a current status of the reward point;

calculating a valuation coefficient of the reward point in combination with the growth parameter and the static parameter; and

calculating a point value by using the valuation coefficient, a ratio of a remaining validity period of the reward point to a total validity period, and price data obtained based on the reward point and a price of the goods redeemed by using the reward point.

It should be understood that the technical solution in this embodiment relates to improvement of a data processing method. The data processing method may be implemented by using a computing device during performing, for example, a general-purpose computer or another known computing device having a similar architecture as that of the general-purpose computer. The computing device may be connected to a network by using a known communications unit, to implement data transmission using a network.

The computing device includes one or more processors and a non-transitory computer-readable medium. The storage medium stores programs and/or codes. The programs and/or code are programmed to implement the following steps in this embodiment when executed by the processor.

In the exemplary embodiments, a computing device is used as an execution body to describe steps of the method and apparatus for cloud service system resource allocation based on terminable reward points. Data used in the exemplary embodiments are respectively from three companies: A, B, and C. However, one skilled in the art should understand that the method described in the exemplary embodiments is also applicable to point valuation for another company and resource allocation in a cloud service system.

### Embodiment 1

First, point data information is imported into a resource data storage module. The reward point data information includes a point issue volume and consumption volume, and a company financial statement. Information such as macroeconomic data is obtained by using a computer information extraction technology.

Then, a point of company A is valuated in a point value evaluation module by using a computer technology, to determine a resource allocation threshold of a cloud service system.

S101: A computing device obtains economic indicator status data, where a data obtaining manner includes, but is not limited to, calling related information from a server database or extracting related information from a network, and the economic indicator status data is one or more of a nominal gross domestic product, a consumer price index, and a real gross domestic product.

S102: The computing device predicts future macroeconomic indicator data by using the collected economic indicator status data.

S201: The computing device obtains operation data of an issue institution, where a data obtaining manner includes, but is not limited to, calling related information from a server of the issue institution or extracting related information from the network.

S202: The computing device predicts, based on the collected operation data of the issue institution and with reference to the future macroeconomic indicator data, indicator data related to future point issue and active consumption of the institution.

S203: The computing device predicts a future point issue volume and active consumption volume based on the indicator data related to the reward point issue and active consumption of the institution.

S204: After the computer device obtains the related data listed in S101 to S203, an application block chain public key encryption and algorithm encryption module encrypts the data, to ensure the computer security and data security.

S205: The computing device discounts predicted values of the future point issue volume and active consumption volume according to a Markowitz portfolio theory, a Gordon growth model, and a capital asset pricing model (CAPM), to obtain an issue volume present value and an active consumption volume present value. A computer calculation algorithm is optimized based on a model combination, and a sustainable growth target is simulated by using a Gordon growth model calculation module, to improve the computing speed of the computer.

$${R}_{apv} = {\sum }_{t = 1}^{n} \frac{{R}_{at}}{{( 1 + r )}^{t}} , and {O}_{pv} = {\sum }_{t = 1}^{n} \frac{{O}_{t}}{{( 1 + r )}^{t}} ,$$

Rₐₚᵥ is the active consumption volume present value, and Oₚᵥ is the issue volume present value.

In this embodiment, the foregoing parameters are shown in Table 1.

TABLE 1
Point prediction and discounting result of the company A

| | 2016 | 2017E | 2018E | 2019E | 2020E | 2021E | F |
|---|---|---|---|---|---|---|---|
| GDP | 6.70% | 6.90% | 6.80% | 6.80% | 6.80% | 6.80% | 4% |
| CPI | 2% | 2.30% | 2.20% | 2.20% | 2.20% | 2.20% | 1.50% |
| Sales volume | 100 | 200 | 300 | 400 | 600 | 1000 | |
| Growth rate | | 100.00% | 50.00% | 33.33% | 50.00% | 66.67% | 2.50% |
| Marketing | 50 | 120 | 180 | 260 | 400 | 700 | |
| costs | | | | | | | |
| Growth rate | | 140.00% | 50.00% | 44.44% | 53.85% | 75.00% | 2.50% |
| Issue volume | 2000000 | 3000000 | 4000000 | 5000000 | 7000000 | 12000000 | 12300000 |
| Active | 720000 | 1200000 | 1470000 | 1560000 | 2300000 | 3890000 | 3987250 |
| consumption | | | | | | | |
| volume | | | | | | | |
| β | 2.1 | 2.2 | 2.2 | 2 | 1.8 | 1.6 | 1.5 |

| | |
|---|---|
| Issue volume present | 36323710.89 |
| value sum | |
| Active consumption | 12034052.22 |
| volume present value | |
| sum | |

S301: Obtain a value of a growth parameter of the reward point of company A in this embodiment as 0.3313.

S400: The computing device obtains data related to goods redeemed by using the reward point of the issue institution, where a data obtaining manner includes, but is not limited to, calling related information from the server of the issue institution or extracting related information from the network.

S401: Obtain an average book price P_{b} of the reward point based on a goods marked price of a redemption mall of a currently graded point and a currency price replaced with the reward point.

S402: Obtain an average realized price Pᵣ of the reward point based on a goods third-party fair price of the redemption mall of the currently graded point and the currency price replaced with the reward point.

S403: The computing device obtains a Beta coefficient β^{β} of the reward point issue institution and/or a competition average Beta coefficient β_{c} β_{c} of the institution based on the Markowitz portfolio theory and the capital asset pricing model.

S404: The computing device rates a goods liquidity of the reward point redemption mall, where goods having the best liquidity is assigned 1, and goods having the poorest liquidity is assigned 0; and after calculating an average goods liquidity, obtains a liquidity parameter L of the goods redeemed by using the reward point, where L ranges between 0 and 1.

In this embodiment, the foregoing parameters are shown in Table 2.

TABLE 2
Point static indicator of company A

| | Value | Remark |
|---|---|---|
| Pᵣ | 0.5 | Average goods value |
| P_{b} | 1.1 | Average account value |
| β | 2.1 | Beta coefficient |
| β_{c} | 1.8 | Competitor’s average |
| | | Beta coefficient |
| L | 0.6 | Goods liquidity |

S501: Obtain a static parameter of the reward point as 0.2338.

S601: The computing device assigns, based on an operation status of the issue institution, a first weighting coefficient a to the growth parameter, assigns a second weighting coefficient b to the static parameter, and add a product of the growth parameter and the first weighting coefficient to a product of the static parameter and the second weighting coefficient, to obtain a valuation coefficient. In this embodiment, 0.8 and 0.2 are respectively assigned.

S602: Obtain the valuation coefficient of the reward point as 0.3118 in this embodiment.

S701: The computing device obtains a point value based on the valuation coefficient, a ratio of a remaining validity period of the reward point to a total validity period, and the average book price of the reward point.

S702: The computer obtains the data and models listed in S205 to S701, and the application block chain public key encryption and algorithm encryption module encrypts the data, to ensure the computer security and data security.

In this embodiment, a point validity period T is 365 days, a current point validity period D is 237 days, and the reward point value is 0.2227 yuan/point. Then, the reward point value is compared with a price in an intelligent analysis module.

Computer allocated resource information is analyzed through analysis such as comparison with a related historical status. For example, when an evaluated price is higher than an actual price by 0.1 yuan, a CPU calculation resource of 1 GHz needs to be increased.

In this embodiment, a current value of the reward point is 0.2 yuan/point. The current value is lower than the evaluated value, a possibility that a point service volume suddenly increases exists, and computer resource allocation needs to be increased.

A resource allocation requirement is sent to a resource allocating module.

At last, a computer resource in a resource pool is intelligently selected for configuration by using a resource allocating management module.

The resource pool mainly includes a virtual computing resource pool, a virtual network resource pool, and a virtual storage resource pool. The virtual computing resource pool is formed by one or more physical hosts (21-2n) by using a virtualization technology, and mainly includes resources such as a CPU and a memory. The virtual network resource pool is formed by various network devices such as a router, a switch, a firewall, a load balancer by using the virtualization technology, and mainly includes resources such as network bandwidth. The storage resource pool is formed by various storage devices by using the virtualization technology, and mainly includes resources such as a storage capacity and storage I/O. The storage device may be a local storage, an IPSAN, a network attached storage (NAS), an object-based storage, and the like. The resource pool includes several hosts. A plurality of VMs is carried in the hosts and allocates virtual resources to the hosts. Hosts that can perform mutual VM migration form a migration domain. VMs on one host share a computing resource (the CPU, the memory, or the like), a storage resource (the local storage or the storage I/O), and a network resource (network I/O). When a host cannot satisfy a resource required by a VM carried in the host, the QoS of the VM decreases, and VM migration needs to be performed to ensure the QoS of the VM.

If the resource is saturated, the module gives an alarm to prompt for human intervention.

### Embodiment 2

First, point data information is imported into a resource data storage module. The reward point data information includes a point issue volume and consumption volume, and a company financial statement. Information such as macroeconomic data is obtained by using a computer information extraction technology.

Then, a point of company B is valuated in a point value evaluation module by using a computer technology, to determine a resource allocation threshold of a cloud service system.

S101: A computing device obtains economic indicator status data, where a data obtaining manner includes, but is not limited to, calling related information from a server database or extracting related information from a network, and the economic indicator status data is one or more of a nominal gross domestic product, a consumer price index, and a real gross domestic product.

S102: The computing device predicts future macroeconomic indicator data by using the collected economic indicator status data.

S201: The computing device obtains operation data of an issue institution, where a data obtaining manner includes, but is not limited to, calling related information from a server of the issue institution or extracting related information from the network.

S202: The computing device predicts, based on the collected operation data of the issue institution and with reference to the future macroeconomic indicator data, indicator data related to future point issue and active consumption of the institution.

S203: The computing device predicts a future point issue volume and active consumption volume based on the indicator data related to the reward point issue and active consumption of the institution.

S204: The computing device discounts predicted values of the future point issue volume and active consumption volume according to a Markowitz portfolio theory, a Gordon growth model, and a capital asset pricing model, to obtain an issue volume present value and an active consumption volume present value.

$${R}_{apv} = {\sum }_{t = 1}^{n} \frac{{R}_{at}}{{( 1 + r )}^{t}} , and {O}_{pv} = {\sum }_{t = 1}^{n} \frac{{O}_{t}}{{( 1 + r )}^{t}} .$$

Rₐₚᵥ is the active consumption volume present value, and Oₚᵥ is the issue volume present value.

In this embodiment, the foregoing parameters are shown in Table 3.

TABLE 3
Point prediction and discounting result of company B

| | 2016 | 2017E | 2018E | 2019E | 2020E | 2021E | F |
|---|---|---|---|---|---|---|---|
| GDP | 6.70% | 6.90% | 6.80% | 6.80% | 6.80% | 6.80% | 4% |
| CPI | 2% | 2.30% | 2.20% | 2.20% | 2.20% | 2.20% | 1.50% |
| Sales | 500 | 800 | 1600 | 5000 | 10000 | 30000 | |
| volume | | | | | | | |
| Growth rate | | 60.00% | 100.00% | 212.50% | 100.00% | 200.00% | 2.50% |
| Marketing | 100 | 200 | 600 | 2000 | 4000 | 12000 | |
| costs | | | | | | | |
| Growth rate | | 100.00% | 200.00% | 233.33% | 100.00% | 200.00% | 2.50% |
| Issue | 5000000 | 8000000 | 16000000 | 50000000 | 100000000 | 300000000 | 307500000 |
| volume | | | | | | | |
| Active | 1780000 | 3560000 | 10680000 | 35600000 | 71200000 | 213600000 | 218940000 |
| consumption | | | | | | | |
| volume | | | | | | | |
| β | 0.8 | 0.9 | 0.9 | 0.8 | 0.8 | 0.8 | 0.8 |

| | |
|---|---|
| Issue | 1419850430 |
| volume | |
| present | |
| value sum | |
| Active | 1008660259 |
| consumption | |
| volume | |
| present | |
| value sum | |

S301: Obtain a value of a growth parameter of the reward point of the company B in this embodiment as 0.71.

S400: The computing device obtains data related to goods redeemed by using the reward point of the issue institution, where a data obtaining manner includes, but is not limited to, calling related information from the server of the issue institution or extracting related information from the network.

S401: Obtain an average book price P_{b} of the reward point based on a goods marked price of a redemption mall of a currently graded point and a currency price replaced with the reward point.

S402: Obtain an average realized price Pᵣ of the reward point based on a goods third-party fair price of the redemption mall of the currently graded point and the currency price replaced with the reward point.

S403: The computing device obtains a Beta coefficient β^{β} of the reward point issue institution and/or a competition average Beta coefficient β_{c}^{β}^{_{c}} of the institution based on the Markowitz portfolio theory and the capital asset pricing model.

S404: The computing device rates a goods liquidity of the reward point redemption mall, where goods having the best liquidity is assigned 1, and goods having the poorest liquidity is assigned 0; and after calculating an average goods liquidity, obtains a liquidity parameter L of the goods redeemed by using the reward point, where L ranges between 0 and 1.

In this embodiment, the foregoing parameters are shown in Table 4.

TABLE 4
Point static indicator of company B

| | Value | Remark |
|---|---|---|
| Pᵣ | 0.7 | Average goods value |
| P_{b} | 1.2 | Average account value |
| β | 0.8 | Beta coefficient |
| β_{c} | 0.7 | Competitor’s average |
| | | Beta coefficient |
| L | 0.5 | Goods liquidity |

S501: Obtain a static parameter of the reward point as 0.2552.

S601: The computing device assigns, based on an operation status of the issue institution, a first weighting coefficient a to the growth parameter, assigns a second weighting coefficient b to the static parameter, and add a product of the growth parameter and the first weighting coefficient to a product of the static parameter and the second weighting coefficient, to obtain a valuation coefficient. In this embodiment, 0.8 and 0.2 are respectively assigned.

S602: Obtain the valuation coefficient of the reward point as 0.619 in this embodiment.

S701: The computing device obtains a point value based on the valuation coefficient, a ratio of a remaining validity period of the reward point to a total validity period, and the average book price of the reward point.

In this embodiment, a point validity period T is 365 days, a current point validity period D is 153 days, and the reward point value is 0.3113 yuan/point.

Then, the reward point value is compared with a price in an intelligent analysis module.

Computer allocated resource information is analyzed through analysis such as comparison with a related historical status. For example, when an evaluated price is higher than an actual price by 0.1 yuan, a CPU calculation resource of 1 GHz needs to be increased.

In this embodiment, a current value of the reward point is 0.7 yuan/point. The current value is higher than the evaluated value, a possibility that a point service volume suddenly decreases exists, and computer resource allocation needs to be decreased.

A resource allocation requirement is sent to the resource allocating module.

At last, a computer resource in a resource pool is intelligently selected for configuration by using a resource allocating management module.

The resource pool mainly includes a virtual computing resource pool, a virtual network resource pool, and a virtual storage resource pool. The virtual computing resource pool is formed by one or more physical hosts (21-2n) by using a virtualization technology, and mainly includes resources such as a CPU and a memory. The virtual network resource pool is formed by various network devices such as a router, a switch, a firewall, a load balancer by using the virtualization technology, and mainly includes resources such as network bandwidth. The storage resource pool is formed by various storage devices by using the virtualization technology, and mainly includes resources such as a storage capacity and storage I/O. The storage device may be a local storage, an IPSAN, a network attached storage (NAS), an object-based storage, and the like. The resource pool includes several hosts. A plurality of VMs is carried in the hosts and allocates virtual resources to the hosts. Hosts that can perform mutual VM migration form a migration domain. VMs on one host share a computing resource (the CPU, the memory, or the like), a storage resource (the local storage or the storage I/O), and a network resource (network I/O). When a host cannot satisfy a resource required by a VM carried in the host, the QoS of the VM decreases, and VM migration needs to be performed to ensure the QoS of the VM.

If the resource is saturated, the module gives an alarm to prompt for human intervention.

### Embodiment 3

A point of company C is valuated.

S101: A computing device obtains economic indicator status data, where a data obtaining manner includes, but is not limited to, calling related information from a server database or extracting related information from a network, and the economic indicator status data is one or more of a nominal gross domestic product, a consumer price index, and a real gross domestic product.

S102: The computing device predicts future macroeconomic indicator data by using the collected economic indicator status data.

S201: The computing device obtains operation data of an issue institution, where a data obtaining manner includes, but is not limited to, calling related information from a server of the issue institution or extracting related information from the network.

S202: The computing device predicts, based on the collected operation data of the issue institution and with reference to the future macroeconomic indicator data, indicator data related to future point issue and consumption of the institution.

S203: The computing device predicts a future point issue volume and active consumption volume based on the indicator data related to the reward point issue and active consumption of the institution.

S204: The computing device discounts predicted values of the future point issue volume and active consumption volume according to a Markowitz portfolio theory, a Gordon growth model, and a capital asset pricing model, to obtain an issue volume present value and an active consumption volume present value.

$${R}_{apv} = {\sum }_{t = 1}^{n} \frac{{R}_{at}}{{( 1 + r )}^{t}} , and {O}_{pv} = {\sum }_{t = 1}^{n} \frac{{O}_{t}}{{( 1 + r )}^{t}} .$$

Rₐₚᵥ is the active consumption volume present value, and Oₚᵥ is the issue volume present value.

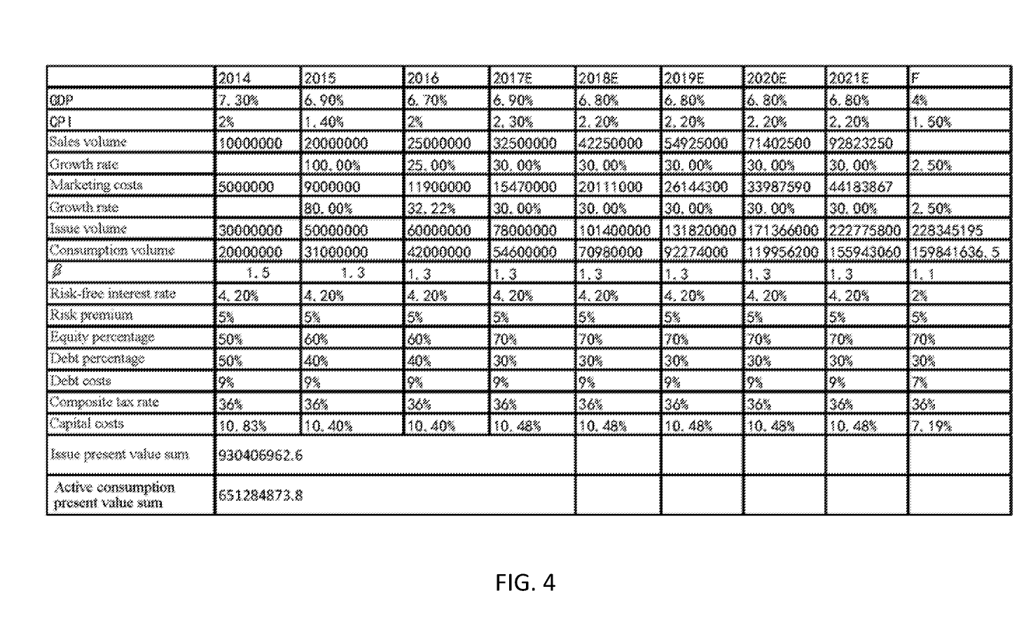

In this embodiment, the reward point prediction and discounting results for company C are shown in FIG. 4.

$$\frac{{R}_{apv}}{{O}_{pv}}$$

S301: Obtain a value of a growth parameter of the reward point of the company C in this embodiment is 0.7.

S400: The computing device obtains data related to goods redeemed by using the reward point of the issue institution, where a data obtaining manner includes, but is not limited to, calling related information from the server of the issue institution or extracting related information from the network.

S401: Obtain an average book price P_{b} of the reward point based on a goods marked price of a redemption mall of a currently graded point and a currency price replaced with the reward point.

S402: Obtain an average realized price Pᵣ of the reward point based on a goods third-party fair price of the redemption mall of the currently graded point and the currency price replaced with the reward point.

S403: The computing device obtains a Beta coefficient β_{β} of the reward point issue institution and/or a competition average Beta coefficient β_{cβ}_{_{c}} of the institution based on the Markowitz portfolio theory and the capital asset pricing model.

S404: The computing device rates a goods liquidity of the reward point redemption mall, where goods having the best liquidity is assigned 1, and goods having the poorest liquidity is assigned 0; and after calculating an average goods liquidity, obtains a liquidity parameter L of the goods redeemed by using the reward point, where L ranges between 0 and 1.

In this embodiment, the foregoing parameters are shown in Table 5.

TABLE 5
Point static indicator of company C

| | Value | Remark |
|---|---|---|
| Pᵣ | 0.68 | Average goods value |
| P_{b} | 0.84 | Average account value |
| β | 1.3 | Beta coefficient |
| β_{c} | 1.58 | Competitor’s average |
| | | Beta coefficient |
| L | 0.62 | Goods liquidity |

$$static parameter = \frac{{P}_{r}}{{P}_{b}} * \frac{{β}_{c}}{β} * L = 0.61 .$$

S501: Obtain a point

S601: The computing device assigns, based on an operation status of the issue institution, a first weighting coefficient a to the growth parameter, assigns a second weighting coefficient b to the static parameter, and add a product of the growth parameter and the first weighting coefficient to a product of the static parameter and the second weighting coefficient, to obtain a valuation coefficient.

In this embodiment, assigned values of the weighting coefficients of the reward point are shown in Table 6.

TABLE 6
Assigned values of the weighting coefficients
of the reward point of company C

| | Value | Remark |
|---|---|---|
| a | 80% | Growth weight |
| b | 20% | Current status weight |

$$\frac{P}{C} = a \frac{{R}_{pv}}{{O}_{pv}} + b \frac{{P}_{r}}{{P}_{b}} * \frac{{β}_{c}}{β} * L = 0.56 + 0.122 = {0.682}^{\frac{P}{C} = a \frac{{R}_{pv}}{{O}_{pv}} + b \frac{{P}_{r}}{{P}_{b}} * \frac{{β}_{c}}{β} * L = 0.56 + 0.122 = 0.682}$$

S602: Obtain the reward point valuation coefficient in this embodiment.

S701: The computing device obtains a point value based on the valuation coefficient, a ratio of a remaining validity period of the reward point to a total validity period, and the average book price of the reward point.

In this embodiment, a point validity period T is 730 days, a current point validity period D is 685 days, and the reward point value is P=P_{b}*P/C*D/T=0.5376 yuan/point.

It will be appreciated for one skilled in the art that parts of or overall process in the above embodiments can be implemented by related hardware controlled by computer program, the computer program can be stored in a computer-readable storage medium, and when the computer program is executed, it can include the processes of the above embodiments of each method. The computer-readable storage medium can be a disc, a compact disc, a Read-Only Memory or a Random Access Memory.

An embodiment of the present invention further provides a computer-readable storage medium storing the computer program that can be executed by one or more processors. The programs are written to perform the foregoing steps S101 to S701. Because specific content of the steps are totally the same, details are not described herein again.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

What is claimed is:

1. A terminable reward point valuation method, comprising:
predicting a development tendency of a point based on economic data related to point operation, and calculating a growth parameter of the reward point;
calculating, based on data related to goods redeemed by using the reward point, a static parameter presenting a current status of the reward point;
calculating a valuation coefficient of the reward point in combination with the growth parameter and the static parameter; and
calculating a point value by using the valuation coefficient, a ratio of a remaining validity period of the reward point to a total validity period, and price data obtained based on the reward point and a price of the goods redeemed by using the reward point.

2. The method according to claim 1, wherein the calculating a valuation coefficient of the reward point in combination with the growth parameter and the static parameter comprises:
assigning a first weighting coefficient to the growth parameter, assigning a second weighting coefficient to the static parameter, and adding a product of the growth parameter and the first weighting coefficient to a product of the static parameter and the second weighting coefficient, to obtain the valuation coefficient.

3. The method according to claim 1, wherein the calculating a point value by using the valuation coefficient, a ratio of a remaining validity period of the reward point to a total validity period, and price data obtained based on the reward point and a price of the goods redeemed by using the reward point comprises:
multiplying the price data by the ratio of the remaining validity period of the reward point to the total validity period and the valuation coefficient to obtain the reward point value.

4. The method according to claim 1, wherein the predicting a development tendency of a point based on economic data related to point operation, and calculating a growth parameter of the reward point comprises:
predicting future macroeconomic indicator data based on past economic indicator status data;
predicting, based on past and current operation data of an issue institution and with reference to the predicted macroeconomic indicator data, indicator data related to future point issue and consumption of the institution;
predicting a future point issue volume and active consumption volume based on the indicator data related to the reward point issue and consumption;
discounting predicted values of the future point issue volume and active consumption volume according to a Markowitz portfolio theory, a Gordon growth model, and a capital asset pricing model, to obtain an issue volume present value and an active consumption volume present value; and
using a ratio of the active consumption volume present value to the issue volume present value as the growth parameter of the reward point.

5. The method according to claim 4, wherein the macroeconomic indicator comprises one or more of a nominal gross domestic product, a consumer price index, and a real gross domestic product.

6. The method according to claim 4, wherein the indicator data related to the future point issue and consumption of the institution comprises one or more of a transaction volume, a sales volume, marketing costs, and a cash flow.

7. The method according to claim 4, wherein the issue volume present value and the active consumption volume present value are calculated by using the following models:
$${R}_{apv} = {\sum }_{t = 1}^{n} \frac{{R}_{at}}{{( 1 + r )}^{t}} , and {O}_{pv} = {\sum }_{t = 1}^{n} \frac{{O}_{t}}{{( 1 + r )}^{t}} ,$$
wherein
Rₐₚᵥ is the active consumption volume present value, and Oₚᵥ is the issue volume present value.

8. The method according to claim 1, wherein a method for obtaining the data related to the goods redeemed by using the reward point comprises: obtaining a price of the reward point based on the reward point and the price data of the goods redeemed by using the reward point.

9. The method according to claim 8, wherein the obtaining a price of the reward point based on the reward point and the price data of the goods redeemed by using the reward point comprises:
obtaining an average book price P_{b} of the reward point based on a goods marked price of a redemption mall of a currently graded point and a currency price replaced with the reward point; and/or
obtaining an average realized price Pᵣ of the reward point based on a goods third-party fair price of a redemption mall of a currently graded point and a currency price replaced with the reward point; and/or
obtaining a beta coefficient β of a point issue institution and/or a competition average Beta coefficient β_{c} of the institution based on a Markowitz portfolio theory and a capital asset pricing model;
rating a goods liquidity of the redemption mall of the currently graded point, and calculating a liquidity of each type of goods, wherein goods having the best liquidity is assigned 1, and goods having the poorest liquidity is assigned 0; and calculating, after calculating an average goods liquidity, a liquidity parameter L of the goods redeemed by using the reward point, wherein L ranges between 0 and 1; and
calculating the static parameter in combination with the average book price P_{b}, the average realized price Pᵣ, the Beta coefficient β of the reward point issue institution, the competition average Beta coefficient β_{c} of the institution, and the liquidity parameter L, wherein a calculation model is:
$$static parameter = \frac{{P}_{r}}{{P}_{b}} * \frac{{β}_{c}}{β} * L .$$

10. A non-transitory computer-readable medium storing programs that can be executed by one or more processors, when executing the programs are executed, the following steps are preformed:
predicting a development tendency of a point based on economic data related to point operation, and calculating a growth parameter of the reward point;
calculating, based on data related to goods redeemed by using the reward point, a static parameter presenting a current status of the reward point;
calculating a valuation coefficient of the reward point in combination with the growth parameter and the static parameter; and
calculating a point value by using the valuation coefficient, a ratio of a remaining validity period of the reward point to a total validity period, and price data obtained based on the reward point and a price of the goods redeemed by using the reward point.
